(19) United States
(12) Patent Application Publication
(10) Pub. No.: US 2026/0296340 A1
(43) Pub. Date: Oct. 1, 2026

(54) VEHICLE SYSTEM WITH PERMANENT POWER SOURCE

(71) Applicant: Robert Bosch GmbH, Stuttgart (DE)

(72) Inventors: Michael T. White, Livonia, MI (US); Jian Tang, Okemos, MI (US); Cason A. Konzer, Holly, MI (US)

(21) Appl. No.: 19/092,506

(22) Filed: Mar. 27, 2025

(51) Int. Cl. B60R 16/033; G21H 1/00; H01M 10/44

(52) U.S. Cl. CPC B60R 16/033; G21H 1/00; H01M 10/44; B60Y 2400/112; B60Y 2400/3015; B60Y 2400/3017

(57) ABSTRACT

A system may include an independent vehicle system with at least one component and a permanent power source for providing power to the at least one component, the permanent power source having a useful life expectancy greater than or equal to a predetermined useful life expectancy of the at least one component.

### FIELD

Aspects described herein relate to, among other things, a vehicle system with a power source and in some instances a vehicle system with two power sources.

### SUMMARY

Modern vehicles include a number of vehicle systems including advanced driver assistance systems (ADAS), safety systems, and electronic controller unit (ECU) systems, among others. ADAS include adaptive cruise control, automatic emergency braking, blind spot detection, parking assist, and lane departure warning systems. Among other things, ADAS utilize sensors to assist drivers when operating a vehicle. In some instances, ADAS perform with little or no human input or control. Safety and ECU systems can receive input from the ADAS but operate independently from the ADAS.

One example provides a vehicle system including at least one component and a permanent power source for providing power to the at least one component, the permanent power source having a useful life expectancy greater than or equal to a predetermined useful life expectancy of the at least one component.

One example provides a vehicle system for a vehicle, the vehicle system including: an independent vehicle system having at least one component powered by a permanent power source, the permanent power source having a useful life expectancy greater than or equal to a predetermined useful life expectancy of the at least one component; and a main vehicle system powered by a main power source different than the permanent power source.

One example provides a method of powering at least one component of a vehicle system for a vehicle, the method including: providing power to a main vehicle system from a main power source; and providing power to the at least one component from a permanent power source, the permanent power source having a useful life expectancy greater than or equal to a predetermined useful life expectancy of the at least one component.

Other aspects will become apparent by consideration of the detailed description and accompanying drawings.

### BRIEF DESCRIPTION OF THE DRAWINGS

FIG. 1. is a schematic of a vehicle according to one example.

FIG. 2 illustrates a system of the vehicle from FIG. 1 according to an example.

FIG. 3 is a schematic of a vehicle with a vehicle system having multiple sub-systems according to an example.

FIG. 4 is a schematic of a vehicle with a vehicle system according to aspects described herein.

FIG. 5 illustrates a schematic of a system, such as one of the systems previously described herein, according to one example.

FIG. 6 illustrates a schematic of a system, such as one of the systems previously described herein, according to one example.

FIG. 7 is a flow chart illustrating a method of powering at least one component of the vehicle system described herein.

### DETAILED DESCRIPTION

Before any examples, features, and aspects are explained in detail, it is to be understood that the disclosure is not limited in its application to the details of construction and the arrangement of components set forth in the following description or illustrated in the following drawings. The examples, features, and aspects are capable of other implementations and of being practiced or of being carried out in various ways.

Also, it is to be understood that the phraseology and terminology used herein is for the purpose of description and should not be regarded as limiting. The terms “mounted,” “connected,” and “coupled” are used broadly and encompass both direct and indirect mounting, connecting, and coupling. Further, “connected” and “coupled” are not restricted to physical or mechanical connections or couplings, and can include electrical connections or couplings, whether direct or indirect. Also, electronic communications and notifications may be performed using known means including wired connections, wireless connections, etc.

The disclosure herein generally relates to a vehicle system for vehicles. In some instance, the vehicles may include “autonomous” vehicles (as explained in more detail below. In one example, the vehicle system is described according to advanced drive assistance system (ADAS) and zone architectures configured to, among other things, be powered at least in part by a permanent self-sustained power source. In other words, at least one power source for the vehicle system requires no charging, re-charging, or replacement over the course of the life of the vehicle. Zone/zonal architecture is a term used herein that relates to the field of vehicle computer organization.

The term “autonomous vehicle” is used in an inclusive way to refer to an autonomous (little or no driver input required) or partially autonomous (some or substantial driver input required) vehicle. The term “driver,” as used herein, generally refers to an occupant of a vehicle, who operates the controls of the vehicle or provides control input to the vehicle to influence the operation of the vehicle.

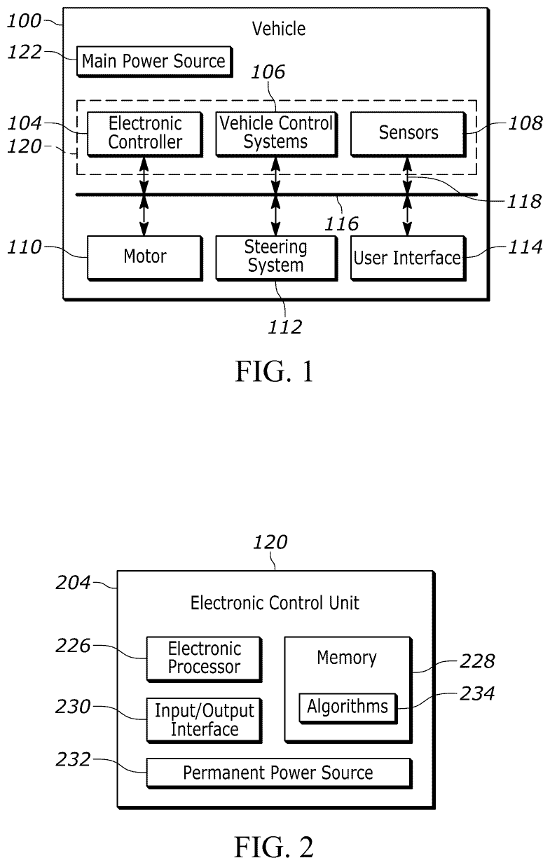

FIG. 1 is a schematic of a vehicle 100 according to one example. In the illustrated example, the vehicle 100 includes an electronic controller 104, a vehicle control system 106, a plurality of sensors 108 installed on and/or within the vehicle 100, a motor 110, a steering system 112 (e.g., including a steering wheel, steering rack, one or more steering axles, tires, etc.) for steering a front and/or rear axle of the vehicle 100, and a user interface 114. The vehicle 100 includes a main power source 122, by way of example a 12V, 24V, or 48V lead-acid battery or lithium-ion battery. The main power source 122 may have a useful life of three to ten (3-10) years and require periodic reoccurring charging cycles. The components of the vehicle 100, along with other various modules and components are electrically and communicatively coupled to each other via direct connections or by or through one or more control or data buses (for example, a bus 116), which enable communication therebetween. The bus 116 may provide a signal 118, including, among other things, information regarding surrounding vehicles. The use of control and data buses for the interconnection between, and communication among, the various modules and components would be known to a person skilled in the art. In some instances, the bus 116 is a controller area network (CAN) bus. In some instances, the bus 116 is an automotive Ethernet, a FlexRay™ communications bus, or another suitable bus. In some instances, some or all of the components of the vehicle 100 may be communicatively coupled using suitable wireless modalities (for example, Bluetooth™ or near field communication connections).

A vehicle system 120 may include some or all of the parts associated with the electronic controller 104, the vehicle control systems 106, and the sensors 108.

The electronic controller 104 (described in greater detail below with respect to FIG. 2) communicates with the vehicle control systems 106 and the sensors 108. The electronic controller 104 may receive sensor data from the sensors 108 and determine control commands for the vehicle 100. The electronic controller 104 transmits the control commands to, among other things, the vehicle control systems 106 to operate or assist in operating the vehicle 100 (for example, by generating braking signals, acceleration signals, steering signals). In some instances, the electronic controller 104 is part of one or more vehicle controllers that implement autonomous or partially autonomous control of the vehicle 100.

The vehicle control systems 106 may include controllers, actuators, and the like for controlling aspects of the operation of the vehicle 100 (for example, acceleration, braking, shifting gears, and the like). The vehicle control systems 106 communicate with the electronic controller 104 via the bus 116.

The sensors 108 measure one or more attributes of the vehicle 100 and the environment around the vehicle 100 and communicate information regarding those attributes to the other components of the vehicle 100 using, for example, messages transmitted on the bus 116. The sensors 108 may include, for example, one or multiple of different classes of environment sensors including ultrasonic sensors, lidar-based sensors, radar sensors, cameras, or others to monitor the environment. Additional sensors including sensors that detect accelerator pedal position and brake pedal position, wheel speed sensors, steering angle sensors, vehicle speed sensors, yaw, pitch, and roll sensors, Hall effect sensors, force sensors, torque sensors, and rotor position sensors are also contemplated. In some instances, the sensors 108 are similar to sensor sets used in an electronic stability control (ESC) system and similar vehicle control systems.

In some instances, the electronic controller 104 controls aspects of the vehicle 100 based on commands received from the user interface 114. The user interface 114 provides an interface between the components of the vehicle 100 and an occupant (for example, a driver) of the vehicle 100. The user interface 114 is configured to receive input from the driver, receive indications of vehicle status from the system's controllers (for example, the electronic controller 104), and provide information to the driver based on the received indications. The user interface 114 provides visual output, such as, for example, graphical indicators (for example, fixed or animated icons), lights, colors, text, images, combinations of the foregoing, and the like. The user interface 114 includes a suitable display mechanism for displaying the visual output, such as, for example, a liquid crystal display (LCD) touch screen, or an organic light-emitting diode (OLED) touch screen), or other suitable mechanisms. In some instances, the user interface 114 displays a graphical user interface (GUI) (for example, generated by the electronic controller 104 and presented on a display screen) that enables a driver or passenger to interact with the vehicle 100. The user interface 114 may also provide audio output to the driver via a chime, buzzer, speaker, or other suitable device included in the user interface 114 or separate from the user interface 114. In some instances, user interface 114 provides haptic outputs to the driver by vibrating one or more vehicle components (for example, the vehicle's steering wheel and the seats), for example, using a vibration motor. In some instances, user interface 114 provides a combination of visual, audio, and haptic outputs.

FIG. 2 illustrates the vehicle system 120 according to an example. The vehicle system 120 includes multiple components, including but not limited to, an electronic control unit (ECU) 204, which includes an electronic processor 226 (for example, a microprocessor, application specific integrated circuit, etc.), a memory 228, and an input/output interface 230. A permanent power source 232 provides power to at least one of the components of the vehicle system 120. It is also contemplated that the entire vehicle system 120 is powered by the permanent power source 232.

The permanent power source 232 stores power for sustaining all or some of the components of the vehicle system 120. In other words, the permanent power source 232 has a useful life expectancy that is the equal to or greater than a predetermined useful life expectancy associated with the components receiving power from the permanent power source 232 in the vehicle system 120. The predetermined useful life expectancy depends on the vehicle 100 and the components therein. The permanent power source 232 is useful for providing power to systems and components that come with the vehicle 100 and are meant to support the vehicle 100 over the course of the predetermined useful life expectancy. In some examples the predetermined useful life expectancy ranges from ten to fifty (10-50) years. The permanent power source 232 requires no charging and/or re-charging throughout the predetermined useful life expectancy. Additionally, the permanent power source 232 is internally placed within the vehicle system 120, e.g., permanently attached to the component/system the permanent power source 232 is powering. In one example the permanent power source 232 has a useful life expectancy from ten to twenty (10-20) years. In one example the permanent power source 232 is an atomic battery. Any reference made to a permanent power source herein is for any power source capable of providing power to the system/sub-system/component for the entire life of the system/sub-system/component and requiring zero replacement, re-charging cycles, charging, and/or maintenance.

The memory 228 may be made up of one or more non-transitory computer-readable media and includes at least a program storage area and a data storage area. The program storage area and the data storage area can include combinations of different types of memory, such as read-only memory (“ROM”), random access memory (“RAM”), electrically erasable programmable read-only memory (“EEPROM”), flash memory, or other suitable memory devices. The electronic processor 226 is coupled to the memory 228 and the input/output interface 230. The electronic processor 226 sends and receives information (for example, from the memory 228 and/or the input/output interface 230) and processes the information by executing one or more software instructions or modules, capable of being stored in the memory 228, or another non-transitory computer readable medium. The software can include firmware, one or more applications, program data, filters, rules, one or more program modules, and other executable instructions. The electronic processor 226 is configured to retrieve from the memory 228 and execute, among other things, software for performing methods as described herein.

In the example illustrated, the memory 228 stores, among other things one or more algorithms 234. The plurality of algorithms 234 may include a battery life algorithm, a breaking algorithm, a parking algorithm, a cruise control algorithm, or the like.

The input/output interface 230 transmits and receives information from devices external to the ECU 204 (for example, components of the vehicle 100 via the bus 116). It should be understood that the vehicle system 120 may include additional components than those illustrated in FIG. 2 and in various configurations. For example, in some examples, the system 230 includes multiple ECUs 204, multiple electronic processors 226, multiple memories 228, multiple input/output interfaces 230, or a combination thereof.

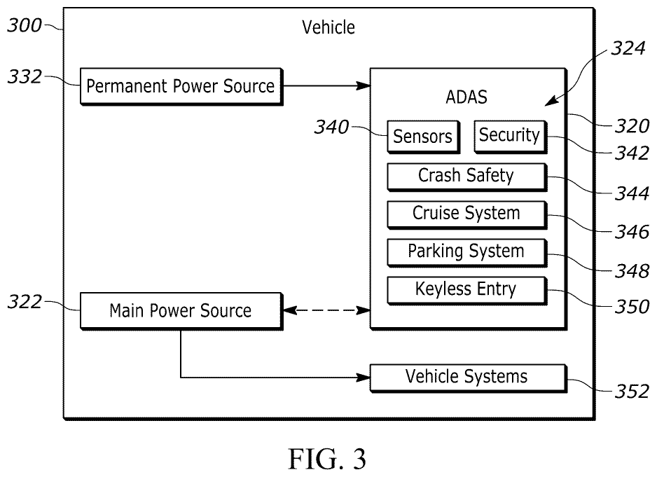

FIG. 3 is a schematic of a vehicle 300 with a vehicle system 320, by way of example an ADAS, having multiple sub-systems 324, referred to herein simply as systems 324, according to aspects described herein.

The vehicle 300 includes a main power source 322, e.g. a vehicle battery, and a permanent power source 332, e.g. an atomic battery. The vehicle system 320 is powered by the permanent power source 332. The systems 324 may include a sensor system 340, a security system 342, a crash safety system 344, a cruise control system 346, a parking system 348, and a keyless entry system 350. Other vehicle systems 352 are powered by the main power source 322.

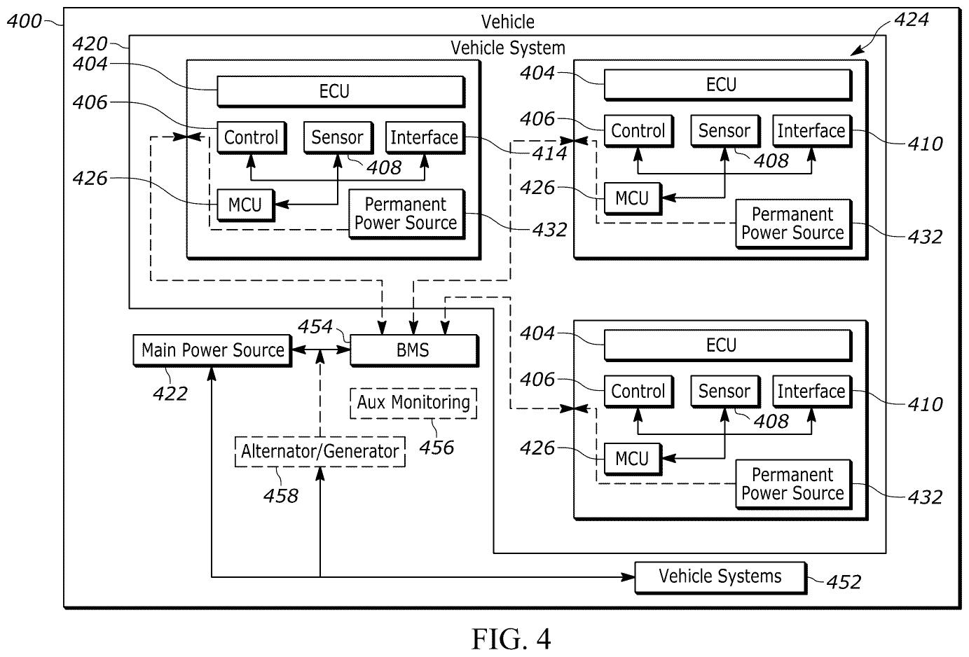

FIG. 4 is a schematic of a vehicle 400 with a vehicle system 420 according to aspects described herein. The vehicle system 420 may be an ADAS with multiple systems 424, by way of example any of the systems 324 previously described herein. Each system 424 includes a dedicated ECU 404. Each ECU 404 includes multiple components, including but not limited to, a control module 406, a sensor module 408, an interface 410, and a processing unit, e.g., a microprocessor MCU 426. Each ECU 404 is powered by a permanent power source 432.

The vehicle 400 includes a main power source 422, e.g. a vehicle battery. A power sharing system, for example a battery management system (BMS) 454, is connected to the main power source 422 and each of the multiple systems 424. The BMS 454 monitors a voltage, temperature, and charge of the main power source 422. The power sharing system may further include an auxiliary power monitoring system 456. The auxiliary power monitoring system 456 may monitor auxiliary power sources (not shown). The auxiliary power sources may include power sources with useful life expectancies that are less than the first useful life expectancy. The auxiliary power sources require charging and/or re-charging. In a hybrid and/or an internal combustion vehicle an alternator/generator 458 is included and connected to the main power source 422.

Additional vehicle systems 452 are also connected to and powered by the main power source 422. The BMS 454 and/or the auxiliary power monitoring system 456 are configured to distribute power from the main power source 422, the auxiliary power sources, and power from the permanent power source 432 to the other vehicle systems 452 and to the vehicle system 420 based on a determined factor. The determined factor may be cost, advanced feature support, safety, security, and customer input.

For example, one of the systems 324 is the sensor system 340. The sensor system 340 may include vehicle-to-other (V2X), vehicle-to-vehicle (V2V), and vehicle-to-infrastructure (V2I) communication capabilities. In one example of the sensor system 340, the ECU 404 is a radar perception processing ECU. The sensor module 408 of the sensor system 340 is in communication with multiple radar sensors located on an exterior of the vehicle 400. By way of example radar sensors are located at a front, side, rear, and corner of the vehicle.

In one example of the sensor system 340, the ECU 404 is an ultrasonic perception processing ECU. The sensor module 408 of the sensor system 340 is in communication with multiple Ultrasonic sensors located on an exterior of the vehicle 400. The ultrasonic sensors may be utilized by the sensor module 408 for parking and/or object detection systems.

In one example of the sensor system 340, the ECU 404 is a lidar perception processing ECU. The sensor module 408 of the sensor system 340 is in communication with multiple lidar sensors located on an exterior or interior of the vehicle 400. The lidar sensors may be mechanical rotary, MEMS, or chip-based sensors.

In one example of the sensor system 340, the ECU 404 is a video processing ECU. The sensor module 408 of the sensor system 340 is in communication with camera sensors located on an exterior or interior of the vehicle 400. The camera sensors may be configured to capture a surround view, a front view, and a rear view of the vehicle.

For example, one of the systems 324 is the security system 342. In one example of the security system 342, the control module 406 includes door locks and window seals. The sensor module 408 is in communication with auditory sensors. The interface 410 may be a dedicated security system interface integral with a main interface (e.g., user interface 114) in the vehicle 400, or an interface integral with a user's smartphone or other smart device for remote control. An example MCU 426 may include algorithms with instructions and actions to take in response to an auditory event such as a loud noise proximate to the vehicle 400. For example, in response to a loud event locking the doors to the vehicle 400 and sealing the windows of the vehicle 400.

For example, one of the systems 324 is the crash safety system 344. In one example of the crash safety system 344, the control module 406 includes a steering control and the sensor module 408 is in communication with camera sensors. The interface 410 may be a dedicated crash safety interface integral with a main interface (e.g., user interface 114) in the vehicle 400, or an interface integral with a user's smartphone or other smart device for remote control. An example algorithm 412 may include instructions and actions to take in response to a potential colliding object when the vehicle 400 is parked.

For example, one of the systems 324 is the cruise control system 346. In one example of the cruise control system 346 the control module 406 includes pedal control. The sensor module 408 is in communication with pedal sensors and cameras. The interface 410 may be a dedicated cruise control interface integral with a main interface (e.g., user interface 114) in the vehicle 400, or an interface integral with a user's smartphone or other smart device for remote control. An example algorithm 412 may include instructions and actions to take in response to an a rapidly slowing vehicle. For example, in response to a rapidly slowing vehicle, the algorithm sends instructions for the bakes to slow or stop the vehicle.

For example, one of the systems 324 is the parking system 348. In one example of the parking system 348, the control module includes steering control and the sensor module 408 is in communication with cameras. The interface 410 may be a dedicated parking interface integral with a main interface (e.g., user interface 114) in the vehicle 400 or an interface integral with a user's smartphone or other smart device for remote control. An example algorithm 412 may include instructions and actions to take in response to a detected parking spot. For example, in response to detecting a parking spot, the algorithm activates the steering control to park the vehicle in the parking spot.

For example, one of the systems 324 is the keyless entry system 350. In one example of the keyless entry system 350, the control module 406 includes door locks and the sensor module 408 is in communication with a proximity sensor. The interface 410 may be a keyless entry interface integral with a main interface (e.g., user interface 114) in the vehicle 400, or an interface integral with a user's smartphone or other smart device for remote control. An example algorithm 412 may include instructions and actions to take in response to a detected key FOB, by way of example unlocking the vehicle doors.

Other systems 324 are also contemplated. For example, systems and or components not used for traditional ADAS are also contemplated. By way of example transmission control, engine control, body control, gateway, etc.

In another example, the vehicle system 420 may be a zone of the vehicle 400, where the vehicle 400 is organized by zone architecture. Zone architecture enables computing resources, data flows, and/or control functions to be segmented into distinct zones that can each handle tasks autonomously or semi-autonomously. Zone architecture utilizes some or all decentralized control ensuring that each zone manages as many tasks as possible locally. This reduces the need to move data across the entire system and helps isolate failures. The zone could have a single permanent power source for the entire zone or have a dedicated permanent power sources for each component.

By way of example, the vehicle system 420 may be a braking zone for the vehicle 400. In one example of the braking zone, the control module 406 includes brake control and the sensor module 408 includes radar sensor. The interface 410 may be a braking interface integral with a main interface (e.g., user interface 114) in the vehicle 400, or an interface integral with a user's smartphone or other smart device for remote control. An example algorithm 412 may include instructions and actions to take in response to a detected object, by way of example braking to prevent a collision with the detected object.

By way of example, the vehicle system 420 may be a speed zone for the vehicle 400. In one example of the speed zone, the control module 406 includes a speedometer and the sensor module 408 includes wheel speed sensors. The interface 410 may be a speed interface integral with a main interface (e.g., user interface 114) in the vehicle 400, or an interface integral with a user's smartphone or other smart device for remote control. An example algorithm 412 may include instructions for updating a speed reading every second.

The permanent power source 432 implemented as described herein provides always on functionality for the systems/zones described herein. In this way, if an unexpected main power source disconnection occurs, the systems/zones/components powered by the permanent power source 432 are unaffected and enable continued operation of parts of or the entire vehicle 400. Source. For example, the vehicle 400 can execute emergency braking using the braking zone even if the power from the main power source has been disconnected.

Other zones are also contemplated including zones that are location dependent (e.g., the front, left, right, and rear of the vehicle 400) or functional (braking, traction, infotainment, connectivity, occupant-monitoring functions for the vehicle 400). The zones may include sub-systems corresponding to any of the systems 324 previously described herein.

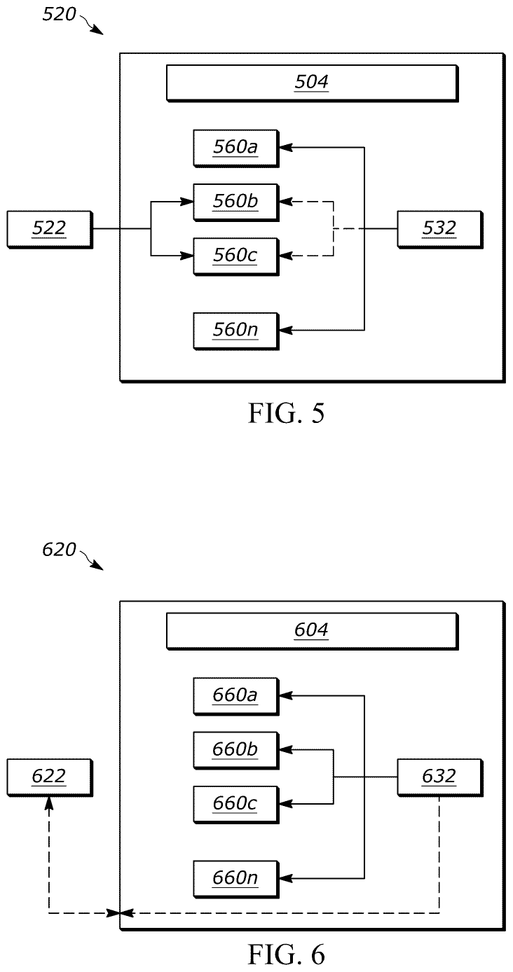

FIG. 5 illustrates a schematic of a system 520, such as one of the vehicle systems and/or sub-systems previously described herein, according to one example. The system 520 includes a dedicated ECU 504 with multiple components including a first set of components 560a, 560n and a second set of components 560b, 560c. The “n” representing any number of appropriate components needed for the system 520. The system 520 is powered at least in part by a permanent power source 532. In one example the first set of components 560a, 560n are always powered by the permanent power source 532. The second set of components 560b, 560c are electrically connected to a main power source 522 and optionally powered by the permanent power source 532.

For example, the system 520 is a vehicle charging system that monitors a state of charge for adjacent systems and/or control modules. For example, the vehicle charging system is the BMS 454 and monitors a state of charge of the main power source 522. In an event where the state of charge falls below a predetermined percentage, the second set of components 560b, 560c draw power from the permanent power source 532. In an event where the main power source 522 is above the predetermined percentage and/or is fully charged, the second set of components 560b, 560c draw power from the main power source 522 and the permanent power source 532 in predetermined time intervals. When the main power source 522 is fully charged the sensor modules for systems discussed herein can be configured to increase sensing frequency.

FIG. 6 illustrates a schematic of a system 620, such as one of the vehicle systems and/or sub-systems previously described herein, according to one example. The system 620 includes a dedicated ECU 604 with multiple components including a first set of components 660a, 660n and a second set of components 660b, 660c. The “n” representing any number of appropriate components needed for the system 620. The system 620 is powered at least in part by a permanent power source 632. In one example the first and second set of components 660a, 660b, 660c, 660n are always powered by the permanent power source 632.

For example, the system 620 is a vehicle charging system that monitors a state of charge for adjacent systems and/or control modules. For example, the vehicle charging system is the BMS 454 and monitors a state of charge of the main power source 622. When the BMS detects a state of charge below a predetermined percentage, the system 620 is configured to draw power from the permanent power source 632 to charge the main power source 622.

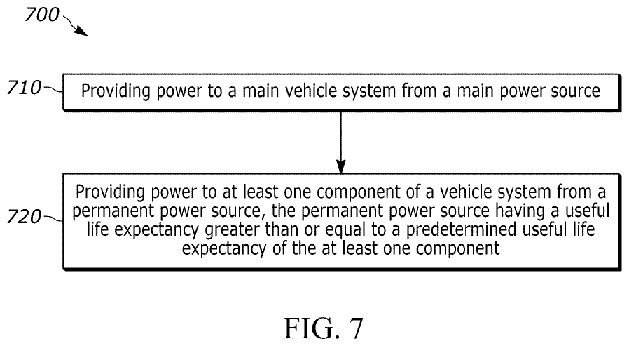

FIG. 7 is a flow chart illustrating a method 700 of powering at least one component of the vehicle systems/sub-systems described herein. The method 700 includes at block 710 providing power to a main vehicle system, (e.g., the vehicle systems 452), from a main power source, (e.g., the main power source 422). At block 720 the method includes providing power to the at least one component, (e.g., the MCU 426), from a permanent power source, (e.g., permanent power source 432), where the permanent power source has a useful life expectancy greater than or equal to a predetermined useful life expectancy of the at least one component.

The method 700 may further include monitoring a state of charge of the main power source 422. In an event where the state of charge falls below a predetermined percentage, the method 700 includes drawing power from the permanent power source to charge the main power source or to power the at least one component of the main vehicle system. For example, the permanent power source 432 is used to charge the main power source 422 or to power the MCU 426 of the vehicle system 452.

In the foregoing specification, specific examples have been described. However, one of ordinary skill in the art appreciates that various modifications and changes can be made without departing from the scope of the claimed subject matter. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting example the term is defined to be within 10%, in another example within 5%, in another example within 1% and in another example within 0.5%. The term “coupled” as used herein is defined as connected, although not necessarily directly and not necessarily mechanically. A device or structure that is “configured” in a certain way is configured in at least that way but may also be configured in ways that are not listed.

It will be appreciated that some examples may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an example can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Additionally, unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

It should also be understood that although certain drawings illustrate hardware and software located within particular devices, these depictions are for illustrative purposes only. In some examples, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations, for example, collectively. To reiterate, those electronic processors and processing may be distributed.

Implementations of the present disclosure are disclosed in the following clauses:
Clause 1. A vehicle system comprising at least one component and a permanent power source for providing power to the at least one component, the permanent power source having a useful life expectancy greater than or equal to a predetermined useful life expectancy of the at least one component.
Clause 2. The vehicle system of clause 1, wherein the at least one component is part of a vehicle charging system for monitoring a state of charge of a main power source different than the permanent power source and is configured to draw power from the permanent power source to charge the main power source when a state of charge of the main power source falls below a predetermined percentage.
Clause 3. The vehicle system of any preceding clause, wherein the at least one component includes a first set of components and a second set of components, the first set of components powered by the permanent power source, the second set of components powered by a main power source different than the permanent power source.
Clause 4. The vehicle system of clause 3, wherein when a state of charge of the main power source is above a predetermined percentage, the second set of components draws power from the permanent power source for predetermined time intervals.
Clause 5. The vehicle system of clauses 3 or 4, wherein a sensor module is configured to increase a sensing frequency when the state of charge of the main power source is above the predetermined percentage.
Clause 6. The vehicle system of clause 5, wherein the sensor module includes at least one sensor selected from a group consisting of radar sensors, ultrasonic sensors, lidar sensors, and cameras.
Clause 7. The vehicle system of clause 1, wherein the vehicle system includes at least one sensor system including sensors selected from a group consisting of radar sensors, ultrasonic sensors, lidar sensors, and cameras.
Clause 8. The vehicle system of clause 7, wherein the at least one component is an electronic control unit (ECU) for the at least one sensor system.
Clause 9. The vehicle system of clause 8, wherein the ECU is at least one selected from a group consisting of radar perception processing, ultrasonic sensing perception processing, lidar perception processing, and video processing.
Clause 10. The vehicle system of any preceding clause, wherein the vehicle system is a zone of a zone architecture for a vehicle, and the zone functions independently from other zones in the zone architecture.
Clause 11. The vehicle system of any preceding clause, wherein the at least one component is multiple components each having a dedicated permanent power source.
Clause 12. The vehicle system of any preceding clause, wherein the permanent power source is an atomic battery.
Clause 13. The vehicle system of any preceding clause, wherein the permanent power source requires zero re-charging cycles over a course of the predetermined useful life expectancy.
Clause 14. A vehicle system for a vehicle, the vehicle system comprising: an independent vehicle system having at least one component powered by a permanent power source, the permanent power source having a useful life expectancy greater than or equal to a predetermined useful life expectancy of the at least one component; and a main vehicle system powered by a main power source different than the permanent power source.
Clause 15. The vehicle system of clause 14, further comprising a power sharing system, wherein power from the main power source and power from the permanent power source are distributed to the main vehicle system and the independent vehicle system based on a determined factor.
Clause 16. The vehicle system of clause 15, wherein the determined factor is selected from a group consisting of cost, advanced feature support, safety, security, and customer input.
Clause 17. The vehicle system of clauses 14-16, wherein the main power source requires periodic reoccurring charging cycles.
Clause 18. The vehicle system of clauses 14-17, wherein the permanent power source requires zero re-charging cycles over a course of the predetermined useful life expectancy.
Clause 19. The vehicle system of clauses 14-18, wherein the at least one component is a sensor selected from a group consisting of radar sensors, ultrasonic sensors, lidar sensors, and cameras.
Clause 20. The vehicle system of clauses 14-19, wherein the at least one component is an electronic control unit (ECU) for a sensor system and wherein the ECU is at least one selected from a group consisting of radar perception processing, ultrasonic sensing perception processing, lidar perception processing, and video processing.
Clause 21. A method of powering at least one component of a vehicle system for a vehicle, the method comprising: providing power to a main vehicle system from a main power source; and providing power to the at least one component from a permanent power source, the permanent power source having a useful life expectancy greater than or equal to a predetermined useful life expectancy of the at least one component.
Clause 22. The method of clause 21, further comprising monitoring a state of charge of the main power source and when the state of charge falls below a predetermined percentage drawing power from the permanent power source to charge the main power source or to power the at least one component of the main vehicle system.
Clause 23. The method of clauses 21 or 22, wherein the permanent power source requires zero re-charging cycles over a course of the predetermined useful life expectancy.

1. A vehicle system comprising:
an advanced driver assistance system (ADAS) having a first set of components; and
a permanent power source electrically connected to the ADAS for providing power to the first set of components, wherein the permanent power source stores power for sustaining the first set of components for a predetermined useful life expectancy of the first set of components, and wherein the permanent power source requires zero re-charging cycles over a course of the predetermined useful life expectancy.

2. The vehicle system of claim 1, further comprising a vehicle charging system for monitoring a state of charge of a main power source different than the permanent power source, the vehicle charging system configured to draw power from the permanent power source to charge the main power source when a state of charge of the main power source falls below a predetermined percentage.

3. The vehicle system of claim 1, further comprising a second set of components powered by a main power source different than the permanent power source.

4. The vehicle system of claim 3, wherein when a state of charge of the main power source is above a predetermined percentage, the second set of components draws power from the permanent power source for predetermined time intervals.

5. The vehicle system of claim 4, wherein the first set of components includes a sensor module is configured to increase a sensing frequency when the state of charge of the main power source is above the predetermined percentage.

6. The vehicle system of claim 5, wherein the first set of components includes a sensor module includes at least one sensor selected from a group consisting of radar sensors, ultrasonic sensors, lidar sensors, and cameras.

7. The vehicle system of claim 1, wherein the ADAS includes at least one sensor system including sensors selected from a group consisting of radar sensors, ultrasonic sensors, lidar sensors, and cameras.

8. The vehicle system of claim 7, wherein the first set of components includes an electronic control unit (ECU) for the at least one sensor system.

9. The vehicle system of claim 8, wherein the ECU is at least one selected from a group consisting of radar perception processing, ultrasonic sensing perception processing, lidar perception processing, and video processing.

10. The vehicle system of claim 1, wherein the vehicle system is a zone of a zone architecture for a vehicle, and the zone functions independently from other zones in the zone architecture.

11. The vehicle system of claim 1, wherein the first set of components includes multiple components each having a dedicated permanent power source.

12. The vehicle system of claim 1, wherein the permanent power source is an atomic battery.

13. (canceled)

14. A vehicle system for a vehicle, the vehicle system comprising:
an independent vehicle system having at least one component always powered by a permanent power source, the permanent power source having a useful life expectancy greater than or equal to a predetermined useful life expectancy of the at least one component; and
a main vehicle system powered by a main power source different than the permanent power source.

15. The vehicle system of claim 14, further comprising a power sharing system, wherein power from the main power source and power from the permanent power source are distributed to the main vehicle system and the independent vehicle system based on a determined factor.

16. The vehicle system of claim 15, wherein the determined factor is selected from a group consisting of cost, advanced feature support, safety, security, and customer input.

17. The vehicle system of claim 14, wherein the main power source requires periodic reoccurring charging cycles.

18. The vehicle system of claim 14, wherein the permanent power source requires zero re-charging cycles over a course of the predetermined useful life expectancy.

19. The vehicle system of claim 14, wherein the at least one component is a sensor selected from a group consisting of radar sensors, ultrasonic sensors, lidar sensors, and cameras.

20. The vehicle system of claim 14, wherein the at least one component is an electronic control unit (ECU) for a sensor system and wherein the ECU is at least one selected from a group consisting of radar perception processing, ultrasonic sensing perception processing, lidar perception processing, and video processing.
